(19) United States
(12) Patent Application Publication
(10) Pub. No.: US 2008/0271560 A1
(43) Pub. Date: Nov. 6, 2008

(54) Shifting Device for Transmitting Shift Commands to a Motor Vehicle Transmission

(76) Inventors: Andreas Giefer, Lemforde (DE); Jorg Meyer, Wagenfeld (DE)

Correspondence Address: MCGLEW & TUTTLE, PC, P.O. BOX 9227, SCARBOROUGH STATION, SCARBOROUGH, NY, 10510-9227, US

(21) Appl. No.: 10/595,502

(22) PCT Filed: Oct. 8, 2004
(86) PCT No.: PCT/DE04/02241

§ 371 Date: Apr. 24, 2006

(30) Foreign Application Priority Data
Oct. 24, 2003 (DE) 103 49 969.5

(51) Int. Cl. B60K 20/00

(52) U.S. Cl. 74/473.1

(57) ABSTRACT

A shifting device (1), for the transmission of shifting commands to a vehicle gearbox includes a housing (2) and/or a frame, a selector lever (4), transmitting shift commands to the gearbox. A knob (3) provides a grip for the hand of the vehicle driver. An adapter (7) is provided for the knob (3) with an integrated switch (5a). The adapter is fitted to the selector lever (4) and forms a connection point between the selector lever (4) and the knob (3). The shifting device (1) is provided for assembly in a motor vehicle and, preferably after fitting of the shifting device (1), a shifting gate is placed over the selector lever (4).

### CROSS REFERENCE TO RELATED APPLICATION

This is a national phase application of and claims the benefit (35 U.S.C. § 120 and 365(c)) of copending International Application PCT/DE 2004/002241 of Oct. 8, 2004, which designated inter alia the United States and which claims the priority of German Application DE 103 49 969.5 of Oct. 24, 2003. The entire contents of each application is hereby incorporated by reference in its entirety.

### FIELD OF THE INVENTION

The present invention pertains to a shifting device for transmitting shift commands to a motor vehicle transmission.

### BACKGROUND OF THE INVENTION

Shifting devices for transmitting shift commands to a motor vehicle transmission, with a hand knob, which contains a switch, are generally known.

If a switch is integrated in the hand knob, a problem arises in the mounting of the hand knob on the selector lever of the shifting device. A shifting cap—also called a shifting gate—and the hand knob are usually assembled on the assembly line at the motor vehicle manufacturer. If a switch is already integrated in the hand knob, then an electrical connection must be reliably made at the selector lever and be inserted into the hand knob with a plug. Special measures are needed to protect this plug-in connection during the transport of the shifting device to the motor vehicle manufacturer. There is a risk, furthermore, that failures must be taken into account due to defective mounting of the plug-in connection with the hand knob.

An improvement has already been made in the hand knob to solve the problem of the “mounting of the hand knob” In this improved embodiment, the switch is already preassembled at the selector lever as a separate component with most of the electrical switch connections. The hand knob only contains the actuating mechanism and the part of the switch exposed to view and is assembled at the motor vehicle manufacturer. Since the switch is exposed at the selector lever, special safety measures and thus cost outlays are always still necessary during transport. Moreover, the switch may be damaged due to improper assembly of the hand knob on the belt; consequently, assembly errors and certain numbers of rejects must also still be taken into account here. This improved hand knob with switch thus still does not represent a satisfactory solution to the “hand knob assembly problem.”

### SUMMARY OF THE INVENTION

Therefore, the object of the present invention is to design a shifting device with hand knob and switch, such that a simple and reliable hand knob assembly can be performed at the motor vehicle manufacturer after installation of the shifting device, without switch connections having to be inserted. Moreover, expensive and complicated safety precautions for the switch and its feed lines should not be necessary on the transport path from the manufacturer of the shifting device to the motor vehicle manufacturer.

Accordingly, it is suggested to improve a shifting device for transmitting shift commands to a motor vehicle transmission, with a housing and/or a frame (hereinafter frame, support structure or housing), a selector lever that transmits shift commands to the transmission, a hand knob that forms a gripping surface for the hand of the motor vehicle driver, and a switch. The shifting device is provided for installation in a motor vehicle and a shifting gate is pushed over the selector lever preferably after installation of the shifting device in a motor vehicle, to the effect that an adapter is provided for the hand knob with integrated switch, which can be mounted at the selector lever and forms a connection point between selector lever and hand knob.

Consequently, it is achieved that a shifting device is now available, in which, the switch, whose electrical and/or optical feed lines are laid and fastened orderly at the selector lever by the manufacturer of the shifting device. If such a shifting device, which is provided for installation in a motor vehicle, is transported to the manufacturer of the motor vehicle, complicated safety measures for the switch and feed lines are no longer necessary for this now. Moreover, the work time for mounting such safety devices is saved at the manufacturer of the shifting device. Consequently, material and labor costs can thus be saved.

However, advantages also arise for the motor vehicle manufacturer, who installs this novel shifting device in his vehicles. In the previously used shifting devices, a shifting gate is used as molding in the vehicle usually after the installation of the shifting device in the motor vehicle. Since the hand knob has a larger diameter than the selector lever opening at the shifting gate, the hand knob can be mounted only after the installation of the shifting gate. Before the hand knob is pushed onto the selector lever, the electrical and/or optical connections to the hand knob must be made.

The shifting gate can be pushed over the selector lever with mounted adapter by means of this novel shifting device. Thus, switch connections to the hand knob do not have to be inserted at the vehicle manufacturer. Consequently, assembly errors can be largely prevented.

The novel adapter makes it possible to use various switches. It is thus possible to use the up to now usual electric switches, which switch electrical signals. Since the adapter is designed in such a way that the actuating mechanism of the switch is integrated and is thus protected in the housing of the adapter, an inadvertent destruction of the switch on the transport path or in an assembly step is avoided.

Another possibility is to also integrate optical switches in the adapter. Thus, the adapter may have a switch that transmits an optical signal to the shifting device. The optical transmitting path might be mounted in the selector lever of the shifting device, whereby the selector lever is bored hollow on the inside. Interfering electrical lines, which can be destroyed, above all, during the installation of the shifting device, can be avoided by means of this elegant guiding of the signal path in connection with the transmission of optical signals.

It is favorable if the adapter has a switch interface for a connection cable. By means of this switch interface, connections even for multiwire cables are created, which are used for transmitting shift commands. If electrical feed lines are used, then the switch interface can be embodied by means of a simple plug connection.

In the mounting of the hand knob, there is a risk of damaging electrical or optical lines, such as, for example, optical waveguides. It is favorable to lay such lines at the adapter in a protected manner. For this reason, the adapter may have at least one recess, in which these lines can be laid.

That part of the switch, with which the driver has visual contact and which he touches for actuating the switch, is designated as the switch display part or switch actuating button. The switch actuating mechanism is also usually present in this part. Various variants are offered in the novel shifting device for the mounting of a switch display part.

In a first variant, the switch display part is mounted in the adapter. In this variant, the hand knob, which can be pushed onto the adapter, has an opening at this point for accommodation of the switch display part. The advantage in this mounting is that the hand knob, which only represents an optical accessory in the vehicle, can be performed in a very cost-favorable manner.

However, it may also be favorable to mount the switch display part in the hand knob. If the switch display part is defective, then the hand knob is simply removed from the adapter and replaced with a new one.

Furthermore, it is advantageous if the adapter of the novel shifting device has at least one guide element for positioning the hand knob. Thus, it is consequently guaranteed that the hand knob is fastened to the selector lever. Moreover, a rotation of the hand knob about the selector lever is prevented by means of the guide element.

It is advantageous if the adapter has a boring, into which the selector lever can be at least partially inserted. An as large-area as possible contact with the housing of the adapter can be produced via the walls of the boring; consequently, a rotation or a slipping of the adapter on the selector lever is effectively prevented.

In order to reliably prevent a rotation of or unintentional slipping off of the adapter from the selector lever, it is especially favorable if the adapter has a screwable connection for fastening the adapter to the selector lever.

Instead of the screwable connection, a clippable connection for fastening to the selector lever is also conceivable. An even faster mounting of the adapter on the selector lever is possible by means of such a clippable or snappable connection.

Another connection possibility can be seen in mounting the adapter at the selector lever as a plastic molding in the injection molding process. Consequently, an especially favorable manner of connection is created, which, moreover, makes possible high production numbers.

Other features and advantages of the present invention appear from the subclaims and the following description of preferred exemplary embodiments with reference to the drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of an adapter without the switch display part, which is fastened to a selector lever of a shifting device;

FIG. 2 is a perspective view of the adapter from FIG. 1 with the switch display part;

FIG. 3 a perspective view showing a preassembled unit with an adapter on the selector lever;

FIG. 4 a perspective view showing the shifting device with mounted adapter and hand knob.

### DESCRIPTION OF THE PREFERRED EMBODIMENTS

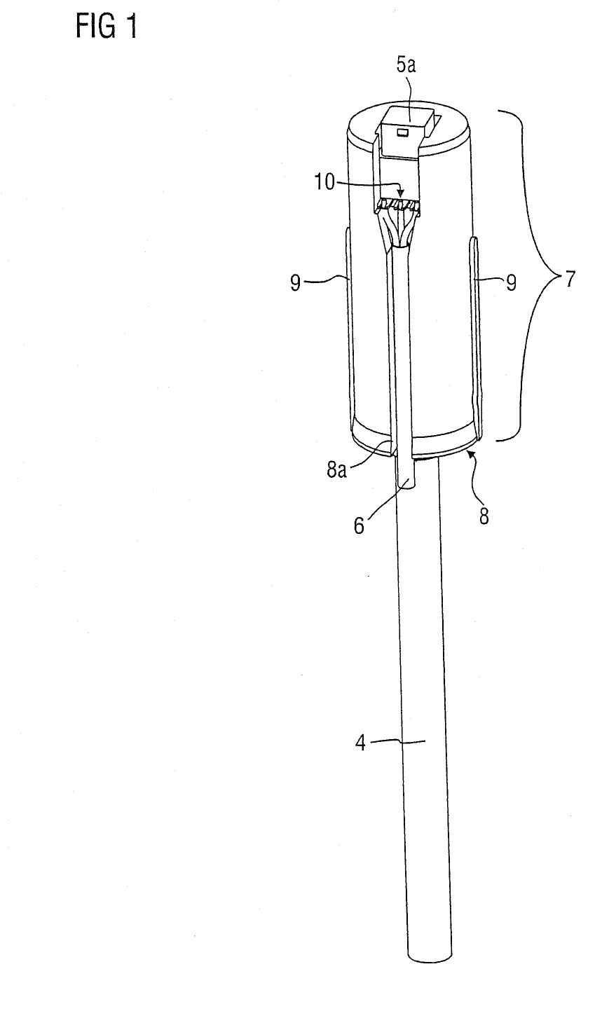

Referring to the drawings in particular, FIG. 1 shows, in a lateral perspective view, an adapter 7 without switch display part, which is fastened to a selector lever 4 of a shifting device. In this embodiment, this adapter 7 consists of a cylindrical housing 8, which has a guide element 9 for the specific accommodation of a hand knob each on the right and left sides. These guide elements 9, which are embodied here as elongated “guide lugs,” are used for positioning the hand knob correctly and for preventing a rotation of the hand knob.

Furthermore, in the upper part of the housing 8, the adapter 7 has a switch 5a, which is used for the functional transmitting of shift commands. Furthermore, an interface 10 for the electrical lines 6 is incorporated in the housing 8 of the adapter 7. The electrical lines 6 are laid in a recess 8a of the housing 8 of the adapter 7 in a protected manner. Consequently, the hand knob 3 can later be pushed over the adapter 7 without being disturbed by the electrical lines 6. Moreover, by means of this laying of the electrical lines 6, the electrical lines 6 are prevented from being destroyed or contacts are prevented from being disconnected during the pushing on of the hand knob 3.

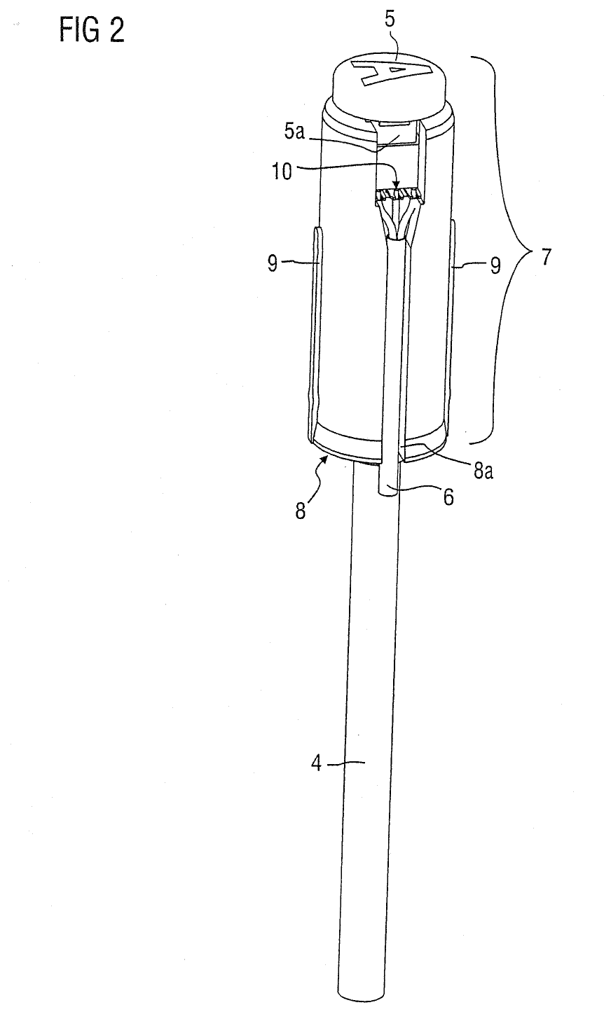

FIG. 2 shows the adapter of FIG. 1, but with an exposed switch state display part 5. This switch display part 5 is fastened at the switch 5a and serves the driver as a manual actuation button which may also provide a switch state display.

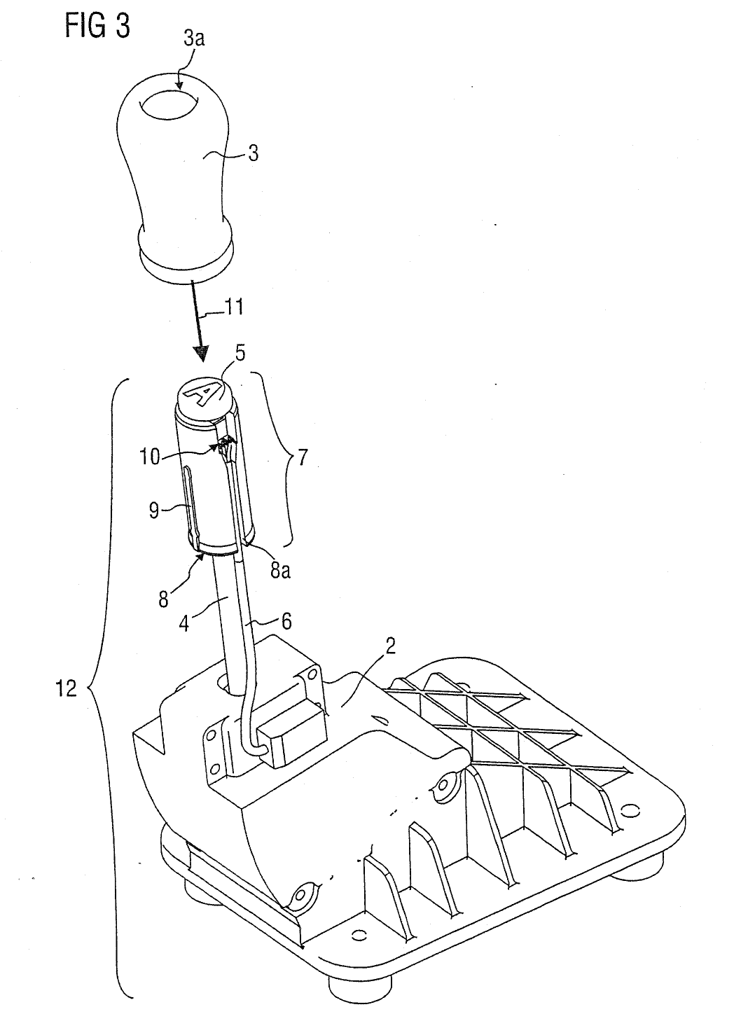

FIG. 3 shows a preassembled unit 12 of a shifting device with an adapter 7 on the selector lever 4. The hand knob 3, which is a separate component of the shifting device, is shown in the upper third of FIG. 3.

A preassembled unit 12 is defined as the already assembled components of a shifting device, as they are delivered by the manufacturer of the shifting device for further installation in a motor vehicle. This preassembled unit 12 consists of a housing 2, in which the shifting movements are accommodated for selecting the transmission positions. A selector lever 4 and the electrical lines 6 extend from this housing 2. An adapter 7 that accommodates the electrical lines 6 at the interface 10 is preassembled on the selector lever 4. The adapter 7 consists of a cylindrical housing 8 that has the switch display part 5 in the upper part. Furthermore, a recess 8a, in which the electrical lines are laid, is incorporated, like a type of groove, in the housing 8 of the adapter 7.

Such a preassembled unit 12 can then be installed in a vehicle at a motor vehicle manufacturer. The motor vehicle manufacturer in this case does not have to mount any electrical connections or plug-in connections between the selector lever 4 and the hand knob 3. A shifting gate, which covers the housing 2 of the shifting device and has openings for the performed selector lever 4, is usually pushed over the selector lever 4 with the adapter 7 (shifting gate is not shown in FIG. 3) via such a preassembled unit 12 at the motor vehicle manufacturer. In order to make it possible to push the shifting gate over the adapter 7, the adapter 7 has an only slightly larger diameter than the selector lever 4, and smaller than the distance between sides of the shift gate passage (shift gap) such that the diameter of the adapter 7 can pass through the shift gap.

After the preassembled unit 12 together with shifting gate is installed in the vehicle, the last step of the assembly can be completed for completing the shifting device, the shifting of the hand knob 3 onto the adapter 7 in the direction of the arrow 11 shown in FIG. 3. So that the hand knob 3, if rotated by mistake, cannot be pushed onto the adapter 7, guide elements 9, which can have different shapes, are present at the adapter 7, which simultaneously prevent a rotation of the hand knob 3 on the adapter 7.

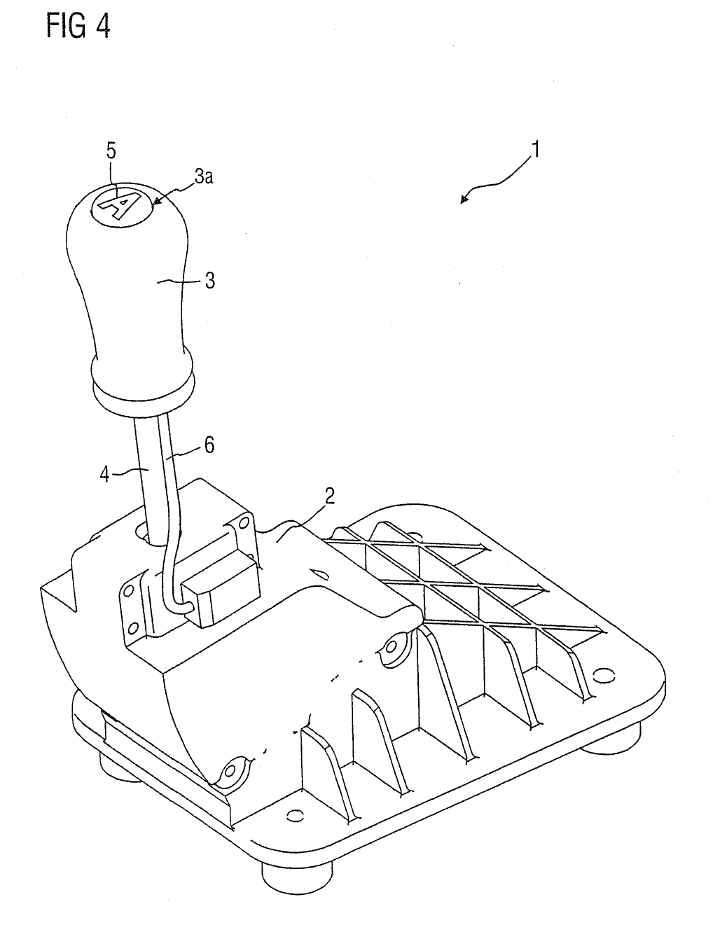

FIG. 4 shows a perspective lateral view of the novel shifting device 1 with hand knob 3 already mounted on the adapter (the adapter is not visible in FIG. 4). Only the switch display part 5 located in the upper part of the housing can be seen through an opening 3a of the hand knob 3. This shifting device 1 consists of a housing 2, in which the shifting gestures are accommodated for selecting the transmission positions, and moreover, a selector lever 4 is mounted at this housing 2. An electrical line 6, which is now stowed within the hand knob 3, is disposed adjacent to the selector lever 4.

Thus, all in all, the present invention provides a shifting device for transmitting shift commands to a motor vehicle transmission with a switch in the hand knob, which offers several advantages over the prior-art shifting devices. The novel shifting device makes possible a transport as a preassembled unit from the manufacturer of the shifting device to the manufacturer of the motor vehicles without any complicated safety measures. This is made possible by the adapter, which accommodates the electrical lines for the switch itself at the selector lever 4 of the shifting device in an orderly and protected manner. However, there are also advantages for the motor vehicle manufacturer, who installs the novel shifting device in vehicles. Thus, the electrical feed lines and the switches in the hand knob no longer have to be connected at the motor vehicle manufacturer. Rather, the adapter makes it possible to install the shifting device 1, then to push a shifting gate over the selector lever 4 together with adapter 7 and, as a last step, to plug the hand knob 3 onto the adapter.

While a specific embodiment of the invention has been shown and described in detail to illustrate the application of the principles of the invention, it will be understood that the invention may be embodied otherwise without departing from such principles.

### APPENDIX

### List of Reference Numbers

1 Shifting device
2 Housing of the shifting device
3 Hand knob
3a Opening in the hand knob for the switch display part
4 Selector lever
5 Switch display part
5a Switch
6 Electrical line
7 Adapter
8 Housing of the adapter
8a Recess in the housing of the adapter
9 Guide element for hand knob
10 Interface for electrical lines
11 Direction of the pushing of the hand knob onto the adapter
12 Preassembled unit of a shifting device

1. A shifting device for transmitting shift commands to a motor vehicle transmission, the shifting device comprising:
a housing/frame support structure;
a selector lever for transmitting shift commands to the motor vehicle transmission;
a hand knob forming a gripping surface for engagement by a hand of a driver of the motor vehicle;
a switch; and
an adapter mounted at said selector lever said having said switch integrated therewith, said adapter defining a connection between said selector lever and said hand knob, the shifting device being provided for installation in a motor vehicle, wherein a shifting gate is pushed over said selector lever.

2. A shifting device in accordance with claim 1, wherein said switch integrated in said adapter includes means for transmitting electrical and/or optical signals.

3. A shifting device in accordance with claim 1, wherein said adapter has a switch interface for a connection cable.

4. A shifting device in accordance with claim 1, further comprising a line for transmitting electrical and/or optical signals wherein said adapter has at least one said recess in which said line is disposed.

5. A shifting device in accordance with claim 1, wherein said adapter has a switch display part.

6. A shifting device in accordance with claim 1, further comprising a switch display part.

7. A shifting device in accordance with claim 1, wherein said adapter has at least one guide element for positioning said hand knob.

8. A shifting device in accordance with claim 1, wherein said adapter has a boring, into which said selector lever can be at least partially inserted.

9. A shifting device in accordance with claim 1, wherein said adapter has a screwable connection for fastening at said selector lever.

10. A shifting device in accordance with claim 1, wherein said adapter has a clippable connection for fastening at said selector lever.

11. A shifting device in accordance with claim 1, wherein said adapter has a plastic molding, which is injection-molded on the selector lever via an injection molding process.

12. A shifting device in accordance with claim 1, wherein said adapter has an actuator button part connected to said switch.

13. A shifting device in accordance with claim 12, wherein said hand knob has an opening for access to said actuator button part.

14. A shifting device in accordance with claim 13, wherein said actuator button part also comprises a switch display part.

15. A shifting device for transmitting shift commands to a motor vehicle transmission, the shifting device comprising:
a support structure;
a selector lever connected to said support structure, said selector lever for transmitting shift commands to the motor vehicle transmission;
an adapter mounted at said selector lever said adapter having an integrated switch;
a hand knob forming a gripping surface for engagement by a hand of a driver of the motor vehicle driver; said adapter defining a connection between said selector lever and said hand knob, the shifting device being provided for installation in a motor vehicle, wherein the diameter of the selector lever and the adapter is smaller than a shift gap defined by side edges of a shift gate whereby the shift gate is passed over said selector lever and said adapter.

16. A shifting device in accordance with claim 15, wherein said integrated switch includes means for transmitting electrical and/or optical signals and has a switch interface for a connection cable.

17. A shifting device in accordance with claim 16, wherein said connection cable has a line for transmitting electrical and/or optical signals wherein said adapter has at least one recess in which said line is disposed.

18. A shifting device in accordance claim 15, wherein said adapter has at least one guide element for positioning said hand knob.

19. A shifting device in accordance with claim 15, wherein said adapter has a part with at least one of an actuator button part and a switch display part connected to said switch.

20. A shifting device in accordance with claim 19, wherein said hand knob has an opening for access to said at least one of an actuator button part and a switch display part connected to said switch.
